(19) United States
(12) Patent Application Publication
(10) Pub. No.: US 2017/0003982 A1
(43) Pub. Date: Jan. 5, 2017

(54) METHOD FOR OPERATING ON WEB PAGE OF TERMINAL AND TERMINAL

(71) Applicant: GIONEE COMMUNICATION EQUIPMENT CO.,LTD.SHENZHEN, Shenzhen, GD (CN)

(72) Inventor: Jinwu HUANG, Shenzhen (CN)

(21) Appl. No.: 14/770,171

(22) PCT Filed: Aug. 5, 2014
(86) PCT No.: PCT/CN2014/083667

§ 371 Date: Aug. 25, 2015

(30) Foreign Application Priority Data
Mar. 21, 2014 (CN) 201410109644.4

(51) Int. Cl. G06F 9/44; G06F 3/0484

(52) U.S. Cl. CPC G06F 9/4443; G06F 3/0484; G06F 3/04817

(57) ABSTRACT

Embodiments of the present disclosure provide a method for operating on web page of a terminal and a terminal. The method can include recording a web page of a terminal in a first time period; obtaining an input operation from a user on the web page of the terminal; obtaining, according to the input operation, an operation instruction corresponding to the input operation in the web page recorded earlier in a second time period; and executing the operation instruction. In embodiments of the present disclosure, a demanded operation icon can be accurately triggered by a user, and thus the content corresponding to the operation icon can be outputted, therefore the user experience can be improved.

### CROSS-REFERENCE TO RELATED APPLICATIONS

This present application claims the benefit of priority to Chinese Patent Application NO. 201410109644.4 filed in Chinese Patent Office on Mar. 21, 2014 and entitled “METHOD FOR OPERATING ON WEB PAGE OF TERMINAL AND TERMINAL”, the content of which is hereby incorporated by reference in its entirety for all intended purposes.

### FIELD

The disclosure relates to a field of human-computer interaction technology, and particularly to, a method for operating on a web page of a terminal and a terminal.

### BACKGROUND

In development of communication technology, image quantity, image resolution and video definition in a webpage can be improved. However, in an amount of locations where the 2G network is still used, a problem that all the contents in the webpage could not be loaded at one time may exist. For instance, since the loading speed of literature content can be fast than that of an image or video content, when the image or video content is loaded, the page arrangement of the webpage may be changed due to the load of the image or video content. When a user contacts a web link or a literature message on the webpage during the webpage content being loaded, since the page arrangement is changed due to the load of the webpage, the position of the web link or the literature message which the user means to tap may also be changed, and thus the user misoperation may be easily caused.

### SUMMARY

Embodiments of the present disclosure provide a method for operating on a web page of a terminal and a terminal, in which a demanded operation icon can be accurately triggered by a user, and thus the content corresponding to the operation icon can be outputted, therefore the user experience can be improved.

An embodiment of the present disclosure can provide a method for operating on a web page of a terminal, comprising:

recording a web page of a terminal in a first time period;

obtaining an input operation from a user on the web page of the terminal;

obtaining, according to the input operation, an operation instruction corresponding to the input operation in the web page recorded earlier in a second time period; and

executing the operation instruction.

Another embodiment of the present disclosure can provide a terminal, comprising:

a recording unit, configured to record a web page of a terminal in a first time period;

a first obtaining unit, configured to obtain an input operation from a user on the web page of the terminal;

a second obtaining unit, configured to obtain, according to the input operation, an operation instruction corresponding to the input operation in the web page recorded earlier in a second time period; and

an executing unit, configured to execute the operation instruction.

Yet another embodiment of the present disclosure can provide a terminal, the terminal comprising a user interface, a memory and a process, wherein the memory stores a set of program code, and by calling a program code stored in the memory, the processor is configured to operate the following steps:

recording a web page of a terminal in a first time period;

obtaining an input operation from a user on the web page of the terminal;

obtaining, according to the input operation, an operation instruction corresponding to the input operation in the web page recorded earlier in a second time period; and

executing the operation instruction.

In an embodiment of the present disclosure, a terminal can firstly record a web page of the terminal in a first time period, then obtain an input operation from a user on the web page of the terminal, and according to the input operation, obtain an operation instruction corresponding to the input operation in the web page recorded earlier in a second time period, after that, execute the operation instruction. In an embodiment of the present disclosure, a demanded operation icon can be accurately triggered by a user, and thus the content corresponding to the operation icon can be outputted, therefore the user experience can be improved.

### BRIEF DESCRIPTION OF THE DRAWINGS

In order to illustrate the embodiments or existing technical solutions more clearly, a brief description of drawings that assists the description of embodiments of the invention or existing art will be provided below. It would be apparent that the drawings in the following description are only for some of the embodiments of the present disclosure. A person having ordinary skills in the art will be able to obtain other drawings on the basis of these drawings without paying any creative work.

FIG. 1 is a flowchart of a method for operating on a web page of a terminal according to an embodiment of the present disclosure.

FIG. 2 is a flowchart of a method for operating on a web page of a terminal according to another embodiment of the present disclosure.

FIG. 3 is a structure schematic diagram of a terminal according to an embodiment of the present disclosure.

FIG. 4 is a structure schematic diagram of a terminal according to another embodiment of the present disclosure.

FIG. 5 is a structure schematic diagram of a terminal according to yet another embodiment of the present disclosure.

FIG. 6 is a structure schematic diagram of a terminal according to yet another embodiment of the present disclosure.

### DETAILED DESCRIPTION OF ILLUSTRATED EMBODIMENTS

Further description of present disclosure will be illustrated clearly and completely, which combined with embodiments in drawings and detailed embodiments. Obviously, the embodiments herein are not all embodiments but only part of embodiments of present disclosure. Based on the embodiments of present disclosure, under premise of without paying out creative work, other embodiments obtained by the person having ordinary skill in the art are considered to encompass within the scope of the present disclosure.

A method for operating on a web page of a terminal and a terminal can be provided, in which a demanded operation icon can be accurately triggered by a user, and thus the content corresponding to the operation icon can be outputted, therefore the user experience can be improved. Detailed illustrations would be described below.

Referring to FIG. 1, it is a flowchart of a method for operating on a web page of a terminal according to an embodiment of the present disclosure. The method shown in FIG. 1 can be applied to a terminal such a smart phone with a touchscreen (a cell phone with Android operating system, a cell phone with an iOS operating system, etc.), a panel PC, a handheld PC, a Mobile Internet Device (MID), a PAD, etc. As shown in FIG. 1, the method can include the following steps.

Step S101, recording a web page of a terminal in a first time period.

In an embodiment of the present disclosure, the first time period can include a time segment earlier in the terminal obtains an input operation from a user on the web page. For instance, assuming the user input operation on the web page may be performed at 8:00 am, and the first time period can be a time segment earlier in 8:00 am, such as 7:59-8:00 am, 7:00-8:00 am, which would not be limited in the embodiment.

Step S102, obtaining an input operation from a user on the web page of the terminal.

Step S103, obtaining, according to the input operation, an operation instruction corresponding to the input operation in the web page recorded earlier in a second time period.

In an embodiment of the present disclosure, the second time period can include a time segment in the first time period, the time segment starts when the terminal detects a user active of approaching to the web page, and the time range of the second time period can be 0-1 second, such as 0.2 s, 0.3 s, which would not be limited in the embodiment.

In an embodiment of the present disclosure, the terminal can detect the user active of approaching to the web page by a distance sensor in the terminal. For instance, a distance threshold (such as 50 mm) can be pre-stored in the terminal, when the distance sensor detects a distance between a user's finger (s), a stylus or a like and the web page of the terminal equals to the pre-stored distance threshold, it means that the terminal has detected the user active of approaching to the distance page, i.e. the user may have a demand of enabling a loaded operation icon in the web page.

In an embodiment of the present disclosure, when the operation instruction corresponding to the input operation is obtained in the web page recorded earlier in the second time period, there may be two situations: one is that the loaded content of the web page may be unchanged; another is that the loaded content of the web page may be changed. If the loaded content of the web page is unchanged, the operation instruction associated with the operation icon, which is corresponding to the user input operation, can be the said operation instruction corresponding to the input operation. For instance, if the user taps the operation icon “exit” in the content of the web page, the operation instruction obtained by the terminal can be the operation instruction associated with the operation icon “exit”, and it can be denoted as the operation instruction corresponding to the input operation.

If the loaded content of the web page is changed, in an optional embodiment, obtaining, according to the input operation, an operation instruction corresponding to the input operation in the web page recorded earlier in a second time period can include:

obtaining a coordinate range corresponding to the input operation;

searching out, according to the coordinate range, an operation icon corresponding to the coordinate range in the web page recorded earlier in the second time period; and

obtaining the operation instruction associated with the operation icon, which is denoted as the operation instruction corresponding to the input operation.

In an embodiment of the present disclosure, for example, the content of the web page in the terminal is changed when the user performs the input operation; assuming the input operation obtained by the terminal is tapping the operation icon “next page” in the screen content, the terminal firstly obtain a first coordinate range of the operation icon “next page”, and search an operation icon corresponding to the first coordinate range in the web page recorded earlier in the second time period (i.e. when the content of the web page in the terminal has not been changed), the found operation icon can be assumed as “exit”, and then the terminal can obtain the operation instruction associated with the operation icon “exit”, which can be denoted as the operation instruction corresponding to the input operation.

If the loaded content of the web page is changed, in an optional embodiment, obtaining, according to the input operation, an operation instruction corresponding to the input operation in the web page recorded earlier in a second time period can include:

postponed loading a content which has not been loaded in the web page of the terminal in a preset third time threshold;

obtaining an operation icon corresponding to the input operation; and

obtaining the operation instruction associated with the operation icon, which is denoted as the operation instruction corresponding to the input operation.

In an embodiment of the present disclosure, the third time threshold can be a time threshold inputted by the user, and can also be a time threshold generated automatically according to the user operating habit, which may not be limited in the embodiment. For example, the terminal can pre-store a third time threshold (such as 500 ms), when the user performs the input operation, the terminal can pause loading the content which has not been loaded in the web page. And thus, enabling the user-demanded operation icon can be more convenient, and the misoperation caused by the changing page arrangement when the user taps the operation icon can be avoided.

Step S104, executing the operation instruction.

In an embodiment of the present disclosure, a terminal can firstly record a web page of the terminal in a first time period, then obtain an input operation from a user on the web page of the terminal, and according to the input operation, obtain an operation instruction corresponding to the input operation in the web page recorded earlier in a second time period, after that, execute the operation instruction. In an embodiment of the present disclosure, a demanded operation icon can be accurately triggered by a user, and thus the content corresponding to the operation icon can be outputted, therefore the user experience can be improved.

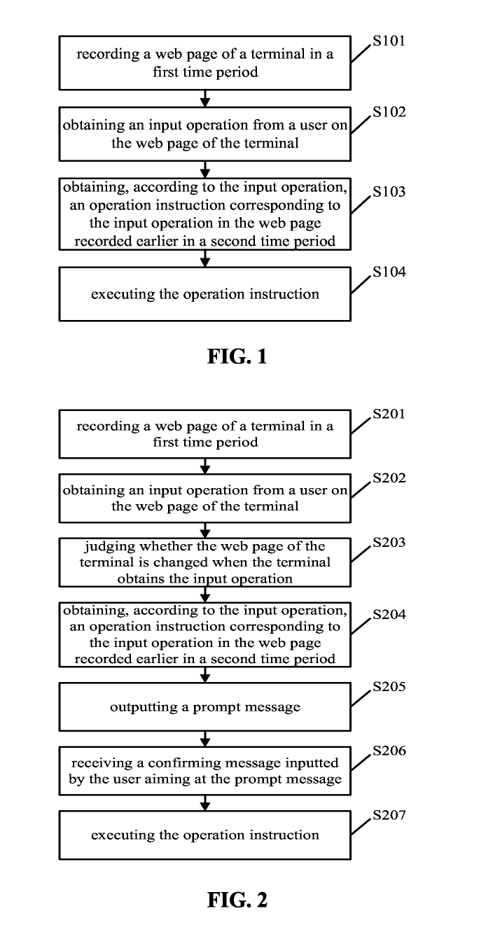

Referring to FIG. 2, it is a flowchart of a method for operating on a web page of a terminal according to another embodiment of the present disclosure. The method shown in FIG. 2 can be applied to a terminal such a smart phone with a touchscreen (a cell phone with Android operating system, a cell phone with an iOS operating system, etc.), a panel PC, a handheld PC, a Mobile Internet Device (MID), a PAD, etc. As shown in FIG. 2, the method can include the following steps.

Step S201, recording a web page of a terminal in a first time period.

In an embodiment of the present disclosure, the first time period can include a time segment earlier in the terminal obtains an input operation from a user on the web page. For instance, assuming the user input operation on the web page may be performed at 8:00 am, and the first time period can be a time segment earlier in 8:00 am, such as 7:59-8:00 am, 7:00-8:00 am, which would not be limited in the embodiment.

Step S202, obtaining an input operation from a user on the web page of the terminal.

Step S203, judging whether the web page of the terminal is changed when the terminal obtains the input operation.

In an embodiment of the present disclosure, judging whether the web page of the terminal is changed can be judging whether the content of the web page is changed, and can also be judging whether the page arrangement of the web page is changed, which may not be limited in the embodiment.

Step S204, obtaining, according to the input operation, an operation instruction corresponding to the input operation in the web page recorded earlier in a second time period.

In an embodiment of the present disclosure, the second time period can include a time segment in the first time period, the time segment starts when the terminal detects a user active of approaching to the web page, and the time range of the second time period can be 0-1 second, such as 0.2 s, 0.3 s, which would not be limited in the embodiment.

In an embodiment of the present disclosure, the terminal can detect the user active of approaching to the web page by a distance sensor in the terminal. For instance, a distance threshold (such as 50 mm) can be pre-stored in the terminal, when the distance sensor detects a distance between a user's finger (s), a stylus or a like and the web page of the terminal equals to the pre-stored distance threshold, it means that the terminal has detected the user active of approaching to the distance page, i.e. the user have a demand of enabling a loaded operation icon in the web page.

In an embodiment of the present disclosure, if the web page of the terminal is judged to be unchanged in step S203, the operation instruction associated with the operation icon, which is corresponding to the user input operation, can be the said operation instruction corresponding to the input operation.

In an embodiment of the present disclosure, if the web page of the terminal is judged to be changed in step S203, in an optional embodiment, obtaining, according to the input operation, an operation instruction corresponding to the input operation in the web page recorded earlier in a second time period can include:

obtaining a coordinate range corresponding to the input operation;

searching out, according to the coordinate range, an operation icon corresponding to the coordinate range in the web page recorded earlier in the second time period; and

obtaining the operation instruction associated with the operation icon, which is denoted as the operation instruction corresponding to the input operation.

In an embodiment of the present disclosure, if the web page of the terminal is judged to be changed in step S203, in an optional embodiment, obtaining, according to the input operation, an operation instruction corresponding to the input operation in the web page recorded earlier in a second time period can include:

postponed loading a content which has not been loaded in the web page of the terminal in a preset third time threshold;

obtaining an operation icon corresponding to the input operation; and

obtaining the operation instruction associated with the operation icon, which is denoted as the operation instruction corresponding to the input operation.

Step S205, outputting a prompt message.

In an embodiment of the present disclosure, the prompt message can be used to prompt the user whether to execute the operation instruction.

Step S206, receiving a confirming message inputted by the user aiming at the prompt message.

In an embodiment of the present disclosure, the terminal can receive a confirming message from the user aiming at the prompt message, and can execute the operation instruction by the confirming message.

Step S207, executing the operation instruction.

In an embodiment of the present disclosure, a demanded operation icon can be accurately triggered by a user, and thus the content corresponding to the operation icon can be outputted, i.e. the user misoperation can be avoided, therefore the user experience can be improved.

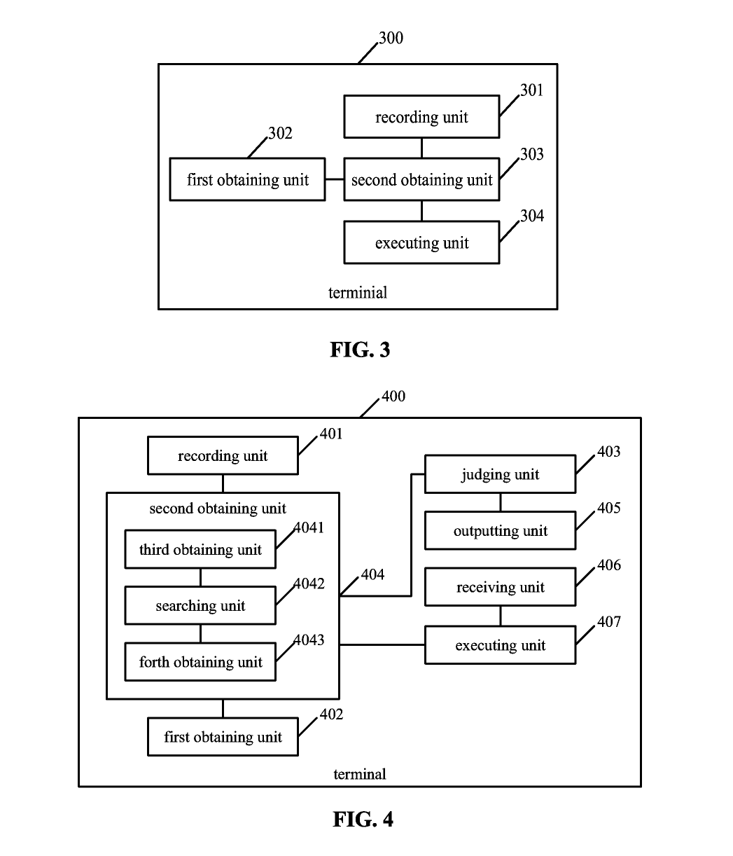

Referring to FIG. 3, it is a structure schematic diagram of a terminal according to an embodiment of the present disclosure. As shown in FIG. 3, the terminal 300 can include a recording unit 301, a first obtaining unit 302, a second obtaining unit 303, and an executing unit 304.

Wherein, the recording unit 301 is configured to obtain an input operation from a user on the web page of the terminal.

In an embodiment of the present disclosure, the first time period can include a time segment earlier in the terminal 300 obtains an input operation from a user on the web page of the terminal 300. For instance, assuming the user input operation on the web page may be performed at 8:00 am, and the first time period can be a time segment earlier in 8:00 am, such as 7:59-8:00 am, 7:00-8:00 am, which would not be limited in the embodiment.

The first obtaining unit 302 is configured to obtain an input operation from a user on the web page of the terminal.

The second obtaining unit 303 is configured to obtain, according to the input operation, an operation instruction corresponding to the input operation in the web page recorded earlier in a second time period.

In an embodiment of the present disclosure, the second time period can include a time segment in the first time period, the time segment starts when the terminal 300 detects the user active of approaching to the web page, and the time range of the second time period can be 0-1 second, such as 0.2 s, 0.3 s, which would not be limited in the embodiment.

In an embodiment of the present disclosure, the terminal 300 can detect the user active of approaching to the web page by a distance sensor in the terminal 300. For instance, a distance threshold (such as 50 mm) can be pre-stored in the terminal, when the distance sensor detects a distance between a user's finger (s), a stylus or a like and the web page of the terminal 300 equals to the pre-stored distance threshold, it means that the terminal has detected the user active of approaching to the distance page, i.e. the user have a demand of enabling a loaded operation icon in the web page.

The executing unit 304 is configured to execute the operation instruction.

In an embodiment of the present disclosure, a demanded operation icon can be accurately triggered by a user, and thus the content corresponding to the operation icon can be outputted, therefore the user experience can be improved.

Referring to FIG. 4, it is a structure schematic diagram of a terminal according to another embodiment of the present disclosure. As shown in FIG. 4, the terminal 400 can include a recording unit 401, a first obtaining unit 402, a judging unit 403, a second obtaining unit 404, an outputting unit 405, a receiving unit 406, and an executing unit 407.

Wherein, the recording unit 401 is configured to record a web page of the terminal 400 in a first time period.

In an embodiment of the present disclosure, the first time period can include a time segment before the terminal 400 obtains an input operation from a user on the web page of the terminal 400. For instance, assuming the user input operation on the web page may be performed at 8:00 am, and the first time period can be a time segment earlier in 8:00 am, such as 7:59-8:00 am, 7:00-8:00 am, which would not be limited in the embodiment.

The first obtaining unit 402 is configured to obtain an input operation from a user on the web page of the terminal.

The judging unit 403 is configured to judge whether the web page of the terminal 400 is changed when the terminal obtains the input operation.

In an embodiment of the present disclosure, the judging unit 403 can judge whether the web page of the terminal 400 is changed by judging whether the content of the web page of the terminal 400 is changed, and can also by judging whether the page arrangement of the web page of the terminal 400 is changed, which may not be limited in the embodiment.

The second obtaining unit 404 is configured to obtain, according to the input operation, an operation instruction corresponding to the input operation in the web page recorded earlier in a second time period.

In an embodiment of the present disclosure, the second time period can include a time segment in the first time period, the time segment starts when the terminal 400 detects a user active of approaching to the web page, and the time range of the second time period can be 0-1 second, such as 0.2 s, 0.3 s, which would not be limited in the embodiment.

In an alternative embodiment, if the judging unit 403 can judge out that the web page of the terminal 400 changed when the terminal 400 obtains the input operation, as shown in FIG. 4, the second obtaining unit 404 can include a third obtaining unit 4041, a searching unit 4042 and a forth obtaining unit 4043.

Wherein, the third obtaining unit 4041 is configured to obtain a coordinate range corresponding to the input operation.

The searching unit 4042 is configured to search out, according to the coordinate range, an operation icon corresponding to the coordinate range in the web page recorded earlier in the second time period.

The forth obtaining unit 4043 is configured to obtain the operation instruction associated with the operation icon.

The outputting unit 405 is configured to output a prompt message when the judging unit 403 judges out the web page of the terminal changed when the terminal 400 obtains the input operation.

In an embodiment of the present disclosure, the prompt message is used to prompt the user whether to execute the operation instruction.

The receiving unit 406 is configured to receive a confirming message inputted by the user aiming at the prompt message.

In an embodiment of present disclosure, the terminal 400 can receive a confirming message from the user aiming at the prompt message, and can execute the operation instruction by the confirming message.

The executing unit 407 is configured to execute the operation instruction.

In an embodiment of the present disclosure, a demanded operation icon can be accurately triggered by a user, and thus the content corresponding to the operation icon can be outputted, therefore the user experience can be improved.

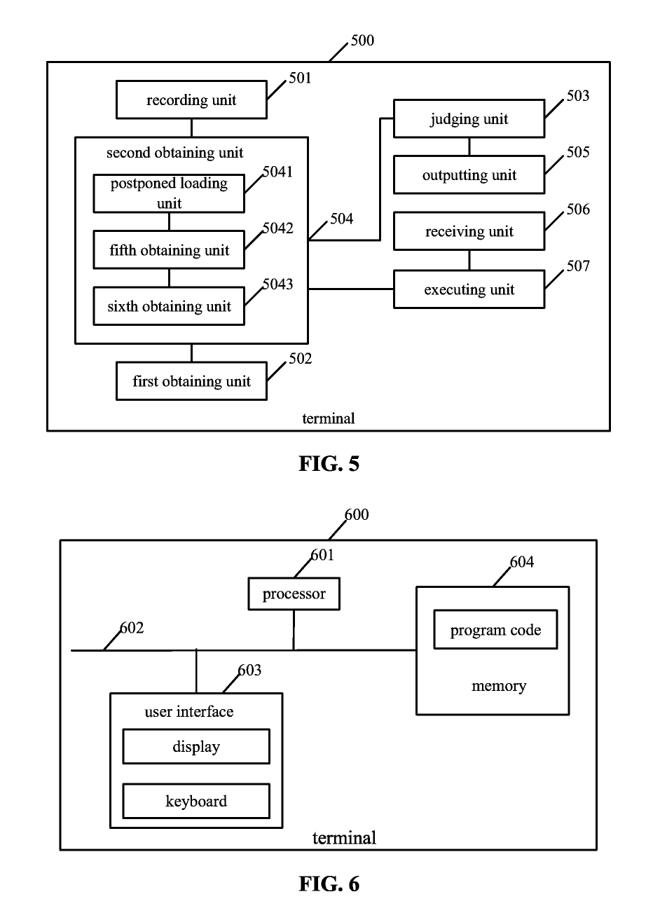

Referring to FIG. 5, it is a structure schematic diagram of a terminal according to yet another embodiment of the present disclosure. As shown in FIG. 5, the terminal 500 can include a recording unit 501, a first obtaining unit 502, a judging unit 503, a second obtaining unit 504, an outputting unit 505, a receiving unit 506, and an executing unit 507.

Wherein, the recording unit 501 is configured to record a web page of the terminal 500 in a first time period.

In an embodiment of the present disclosure, the first time period can include a time segment before the terminal 500 obtains an input operation from a user on the web page of the terminal 500. For instance, assuming the user input operation on the web page may be performed at 8:00 am, and the first time period can be a time segment earlier in 8:00 am, such as 7:59-8:00 am, 7:00-8:00 am, which would not be limited in the embodiment.

The first obtaining unit 502 is configured to obtain an input operation from a user on the web page of the terminal.

The judging unit 503 is configured to judge whether the web page of the terminal 500 is changed when the terminal obtains the input operation.

In an embodiment of the present disclosure, the judging unit 503 can judge whether the web page of the terminal 500 is changed by judging whether the content of the web page of the terminal 500 is changed, and can also by judging whether the page arrangement of the web page of the terminal 500 is changed, which may not be limited in the embodiment.

The second obtaining unit 504 is configured to obtain, according to the input operation, an operation instruction corresponding to the input operation in the web page recorded earlier in a second time period.

In an embodiment of the present disclosure, the second time period can include a time segment in the first time period, the time segment starts when the terminal 500 detects a user active of approaching to the web page, and the time range of the second time period can be 0-1 second, such as 0.2 s, 0.3 s, which would not be limited in the embodiment.

In an alternative embodiment, if the judging unit 503 can judge out that the web page of the terminal 400 changed when the terminal 500 obtains the input operation, as shown in FIG. 5, the second obtaining unit 504 can include a postponed loading unit 5041, a fifth obtaining unit 5042, a sixth obtaining unit 5043.

Wherein, the postponed loading unit 5041 is configured to postponed load a content which has not been loaded in the web page of the terminal in a preset third time threshold.

The fifth obtaining unit 5042 is configured to obtain an operation icon corresponding to the input operation.

The sixth obtaining unit 5043 is configured to obtain the operation instruction associated with the operation icon, which is denoted as the operation instruction corresponding to the input operation.

The outputting unit 505 is configured to output a prompt message when the judging unit 503 judges out the web page of the terminal changed when the terminal 500 obtains the input operation.

In an embodiment of the present disclosure, the prompt message is used to prompt the user whether to execute the operation instruction.

The receiving unit 506 is configured to receive a confirming message inputted by the user aiming at the prompt message.

In an embodiment of present disclosure, the terminal 500 can receive a confirming message from the user aiming at the prompt message, and can execute the operation instruction by the confirming message.

The executing unit 507 is configured to execute the operation instruction.

In an embodiment of the present disclosure, a demanded operation icon can be accurately triggered by a user, and thus the content corresponding to the operation icon can be outputted, therefore the user experience can be improved.

Referring to FIG. 6, it is a structure schematic diagram of a terminal according to yet another embodiment of the present disclosure. As shown in FIG. 6, the terminal 600 can include: at least one processor 601, such as a CPU; at least one user interface 603, a memory 604 and at least one communication bus 602 for implementing connections and communications among these devices. The user interface 603 can include a standard cable interface and a standard wireless interface; the memory 604 can include a high speed RAM storage; or may further include an non-volatile memory, such as at least one magnetic disk memory; or optionally, may further include at least one memory device far apart from the process 601. The memory 604 may store a set of program code, and by calling a program code stored in the memory, the processor 601 can be configured to operate the following steps:

recording a web page of a terminal in a first time period;

obtaining an input operation from a user on the web page of the terminal;

obtaining, according to the input operation, an operation instruction corresponding to the input operation in the web page recorded earlier in a second time period; and

executing the operation instruction.

In an optional embodiment, before the processor 601 obtains, according to the input operation, an operation instruction corresponding to the input operation in the web page recorded earlier in a second time period, by calling a program code stored in the memory 604, the processor 601 is further configured to operate the following steps:

judging whether the web page of the terminal is changed when the terminal 600 obtains the input operation;

if the processor 601 judges out the web page of the terminal 600 changed when the terminal obtains the input operation, before executing the operation instruction, the processor 601 is further configured to operate the following steps:

outputting a prompt message to prompt the user whether to execute the operation instruction; and

receiving a confirming message inputted by the user aiming at the prompt message, to enable the terminal to execute the operation instruction.

In an optional embodiment, if the processor 601 judges out the web page of the terminal changed when the processor 601 obtains the input operation, the step of obtaining, according to the input operation, an operation instruction corresponding to the input operation in the web page recorded earlier in a second time period operated by the process 601 specifically comprises the following steps:

obtaining a coordinate range corresponding to the input operation;

searching out, according to the coordinate range, an operation icon corresponding to the coordinate range in the web page recorded earlier in the second time period; and

obtaining the operation instruction associated with the operation icon, which is denoted as the operation instruction corresponding to the input operation.

In an optional embodiment, if the processor 601 judges out the web page of the terminal changed when the processor 601 obtains the input operation, the step of obtaining, according to the input operation, an operation instruction corresponding to the input operation in the web page recorded earlier in a second time period operated by the process 601 specifically comprises the following steps:

postponed loading a content which has not been loaded in the web page of the terminal 600 in a preset third time threshold;

obtaining an operation icon corresponding to the input operation; and

obtaining the operation instruction associated with the operation icon, which is denoted as the operation instruction corresponding to the input operation.

In an optional embodiment, the time range of the second time period is 0-1 second.

Specifically, the terminal 600 can be used to implement partial or entire flow of a method for operating a web page of a terminal by illustrations with combination of FIG. 1 or FIG. 2.

In an embodiment of the present disclosure, a demanded operation icon can be accurately triggered by a user, and thus the content corresponding to the operation icon can be outputted, therefore the user experience can be improved.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The execution sequence of steps in the method may be modified according to practical requirement. The units of the terminal in embodiments of the present disclosure can be combined or divided according to practical requirement. The terminal in embodiments of the present disclosure can be a cell phone, a computer, a mobile device, etc.

The units or subunits of the terminal in embodiments of the present disclosure can be realized by a common integrated circuit (such as a Central Processing Unit (CPU)), or an Application Specific Integrated Circuit (ASIC).

The above descriptions are some exemplary embodiments of the present disclosure, and should not be regarded as limitation to the scope of related claims. A person having ordinary skills in a relevant technical field will be able to make improvements and modifications within the spirit of the principle of the present disclosure. The improvements and modifications should also be incorporated in the scope of the claims attached below.

1. A method for operating on web page of a terminal, comprising:
recording a web page of a terminal in a first time period;
obtaining an input operation from a user on the web page of the terminal;
obtaining, according to the input operation, an operation instruction corresponding to the input operation in the web page recorded earlier in a second time period; and
executing the operation instruction.

2. The method according to claim 1, wherein before obtaining, according to the input operation, an operation instruction corresponding to the input operation in the web page recorded earlier in a second time period, the method further comprises:
judging whether the web page of the terminal is changed when the terminal obtains the input operation;
if the web page of the terminal is changed when the terminal obtains the input operation, before executing the operation instruction, the method further comprises:
outputting a prompt message to prompt the user whether to execute the operation instruction; and
receiving a confirming message inputted by the user aiming at the prompt message, to enable the terminal to execute the operation instruction.

3. The method according to claim 2, wherein, if the web page of the terminal is changed when the terminal obtains the input operation, the obtaining, according to the input operation, an operation instruction corresponding to the input operation in the web page recorded earlier in a second time period comprises:
obtaining a coordinate range corresponding to the input operation;
searching out, according to the coordinate range, an operation icon corresponding to the coordinate range in the web page recorded earlier in the second time period; and
obtaining the operation instruction associated with the operation icon, which is denoted as the operation instruction corresponding to the input operation.

4. The method according to claim 2, wherein, if the web page of the terminal is changed when the terminal obtains the input operation, the obtaining, according to the input operation, an operation instruction corresponding to the input operation in the web page recorded earlier in a second time period comprises:
postponed loading a content which has not been loaded in the web page of the terminal in a preset third time threshold;
obtaining an operation icon corresponding to the input operation; and
obtaining the operation instruction associated with the operation icon, which is denoted as the operation instruction corresponding to the input operation.

5. The method according to claim 1, wherein the time range of the second time period is 0-1 second.

6. A terminal, comprising:
a recording unit, configured to record a web page of a terminal in a first time period;
a first obtaining unit, configured to obtain an input operation from a user on the web page of the terminal;
a second obtaining unit, configured to obtain, according to the input operation, an operation instruction corresponding to the input operation in the web page recorded earlier in a second time period; and
an executing unit, configured to execute the operation instruction.

7. The terminal according to claim 6, wherein, the terminal further comprises:
a judging unit, configured to judge whether the web page of the terminal is changed when the terminal obtains the input operation, before the second obtaining unit obtains, according to the input operation, an operation instruction corresponding to the input operation in the web page recorded earlier in a second time period;
the terminal further comprises:
an outputting unit, configured to output, if the web page of the terminal is changed when the terminal obtains the input operation and before the executing unit executes the operation instruction, a prompt message to prompt the user whether to execute the operation instruction; and
a receiving unit, configured to receive a confirming message inputted by the user aiming at the prompt message, to enable the terminal to execute the operation instruction.

8. The terminal according to claim 7, wherein the second obtaining unit comprises:
a third obtaining unit, configured to obtain a coordinate range corresponding to the input operation;
a searching unit, configured to search out, according to the coordinate range, an operation icon corresponding to the coordinate range in the web page recorded earlier in the second time period; and
a forth obtaining unit, configured to obtain the operation instruction associated with the operation icon, which is denoted as the operation instruction corresponding to the input operation.

9. The terminal according to claim 7, wherein, the second obtaining unit comprises:
a postponed loading unit, configured to postponed load a content which has not been loaded in the web page of the terminal in a preset third time threshold;
a fifth obtaining unit, configured to obtain an operation icon corresponding to the input operation; and
a sixth obtaining unit, configured to obtain the operation instruction associated with the operation icon, which is denoted as the operation instruction corresponding to the input operation.

10. The terminal according to claim 6, wherein the time range of the second time period is 0-1 second.

11. A terminal, comprising a user interface, a memory and a processor, wherein the memory stores a set of program code, and by calling a program code stored in the memory, the processor is configured to operate the following steps:
recording a web page of a terminal in a first time period;
obtaining an input operation from a user on the web page of the terminal;
obtaining, according to the input operation, an operation instruction corresponding to the input operation in the web page recorded earlier in a second time period; and
executing the operation instruction.

12. The terminal according to claim 11, wherein, before obtaining, according to the input operation, an operation instruction corresponding to the input operation in the web page recorded earlier in a second time period, by calling a program code stored in the memory, the processor is further configured to operate the following steps:
judging whether the web page of the terminal is changed when the terminal obtains the input operation;
if the processor judges out the web page of the terminal changed when the terminal obtains the input operation, before executing the operation instruction, the processor is further configured to operate the following steps:
outputting a prompt message to prompt the user whether to execute the operation instruction; and
receiving a confirming message inputted by the user aiming at the prompt message, to enable the terminal to execute the operation instruction.

13. The terminal according to claim 12, wherein, if the processor judges out the web page of the terminal changed when the processor obtains the input operation, the step of obtaining, according to the input operation, an operation instruction corresponding to the input operation in the web page recorded earlier in a second time period operated by the process specifically comprises the following steps:
obtaining a coordinate range corresponding to the input operation;
searching out, according to the coordinate range, an operation icon corresponding to the coordinate range in the web page recorded earlier in the second time period; and
obtaining the operation instruction associated with the operation icon, which is denoted as the operation instruction corresponding to the input operation.

14. The terminal according to claim 12, wherein, if the processor judges out the web page of the terminal changed when the processor obtains the input operation, the step of obtaining, according to the input operation, an operation instruction corresponding to the input operation in the web page recorded earlier in a second time period operated by the process specifically comprises the following steps:
postponed loading a content which has not been loaded in the web page of the terminal in a preset third time threshold;
obtaining an operation icon corresponding to the input operation; and
obtaining the operation instruction associated with the operation icon, which is denoted as the operation instruction corresponding to the input operation.

15. The terminal according to claim 11, wherein the time range of the second time period is 0-1 second.
